(19) United States
(12) Patent Application Publication
(10) Pub. No.: US 2013/0045332 A1
(43) Pub. Date: Feb. 21, 2013

(54) WINDSHIELD TREATMENT AND WIPER BLADE COMBINATION

(71) Applicants: Jiafu Fang, Spring, TX (US); Liliana Minevski, The Woodlands, TX (US); Kenneth Henry Teal, Houston, TX (US)

(72) Inventors: Jiafu Fang, Spring, TX (US); Liliana Minevski, The Woodlands, TX (US); Kenneth Henry Teal, Houston, TX (US)

(73) Assignee: Illinois Tool Works, Inc., Glenview, IL (US)

(21) Appl. No.: 13/580,729

(22) PCT Filed: Jan. 21, 2011
(86) PCT No.: PCT/US11/22055

§ 371 Date: Aug. 23, 2012

Related U.S. Application Data
(60) Provisional application No. 61/306,668, filed on Feb. 22, 2010.

(51) Int. Cl. B05C 11/04; B05D 3/12

(52) U.S. Cl. 427/358; 118/100

(57) ABSTRACT

A system for creating a water repellant coating on a windshield, comprises a water repellant surface treatment comprising a silicone-containing compound, and a water repellant wiper blade comprising a natural or synthetic or semi-synthetic rubber squeegee body and a water repellant coating comprising a hydrophobic polymeric film former and a hydrophobicity-enabling agent such as polyalkylsiloxane (modified or non-modified) silicone fluids. The polymeric film can be made from a compound selected from the group consisting of polyol resins, urethane resins, fluorine resins, epoxy resins, and silicone resins and may further include a friction reducing agent selected from the group consisting of graphite, PTFE, and molybdenum disulfide powders.

### RELATED CASES

Not applicable.

### FIELD OF THE INVENTION

The invention relates to windshield wiper blades and windshield treatments. More particularly, this invention relates to a combination of glass treatment and wiper blade that provides a surprising synergistic effect.

### BACKGROUND OF THE INVENTION

In order to improve visibility in wet conditions, it is often desired to increase the water repellency of an automobile windshield. A more water-repellant surface causes water to form beads with a high contact angle, and thus allows water droplets to be more easily and completely removed from the surface by action of the wiper blade. To benefit from water repellency for improved driving visibility under raining conditions, a water contact angle of 60° or higher is considered necessary.

Various techniques are known for increasing the water-repellancy of glass surfaces. These include compositions such as those disclosed in U.S. Pat. No. 7,344,783, which discloses the use of a water repellent composition comprising a curing agent and a silicone resin that is preferably a silsesquioxane silicone resin.

A hydrophobic glass treatment offers instant water repellency once the treatment is applied to the windshield surface. Such treatments can be wiped or sprayed on to the surface. Over time, however, the water repellency tends to decrease. This is primarily due to the abrasion action of the wiper blade, but may also be attributable to other factors, such as washing, scraping, etc. For instance, the water contact angle of a windshield freshly treated with a commercial hydrophobic glass treatment has a high water contact angle of about 105°. However, once the treated surface is wiped with a non-hydrophobic wiper blade, the water contact angle starts to drop. After 20,000 wipe cycles, the water contact angle drops to about 65°, and the benefit of the water repellant treatment is eliminated. This durability is roughly equivalent to 3 months under the average real-world conditions in the continental United States.

In addition to surface treatments, there exist hydrophobic wiper blades, which comprise a rubber wiper that has been coated with hydrophobic materials. A hydrophobic wiper blade can cause the wiped windshield surface to become water repelling after an activation phase, typically within 5 minutes of dry wiping. For example, after 175 dry wipe cycles with a commercial hydrophobic wiper blade, the wiped windshield surface is modified from a wettable to a non-wettable (hydrophobic) surface and the water contact angle increases from near zero to about 100 degrees. However, the water contact angle drops rather quickly after the activation phase. At 20,000 wipe cycles with a hydrophobic wiper blade, the water contact angle may have decreased to below 60 degrees and the wiped surface lost most of the water repellency benefit.

Therefore, it remains desired to provide a system that will maintain desired water repellency at desired levels for more than 20,000 wipe cycles.

### SUMMARY OF THE INVENTION

In accordance with preferred embodiments of the invention a system that will maintain desired water repellency at desired levels for more than 20,000 wipe cycles comprises a combination of a surface treatment and hydrophobic wiper blade. The system provides surprising synergistic results that are far superior to what might be expected.

In some embodiments, the invention comprises a system for creating a water repellant coating on a windshield surface, comprising a water repellant surface treatment comprising a silicone-containing compound applied to the surface and a water repellant wiper blade comprising a natural or synthetic or semi-synthetic rubber squeegee body and a water repellant compound comprising a hydrophobic polymeric film former and a hydrophobicity-enabling agent.

The water repellant surface treatment may comprise at least one compound selected from the group comprising: polysiloxanes, chlorosilane compounds, alkoxysilane compounds, silazane compounds, and combinations thereof, the water repellant surface treatment is provided in a carrier fluid in the form of a cream, lotion, emulsion, solution, or solid, the polymeric film former may comprise a compound selected from the group consisting of polyol resins, urethane resins, fluorine resins, epoxy resins, and silicone resins.

The water repellant compound may further include a friction reducing agent selected from the group consisting of graphite, PTFE, and molybdenum disulfide powders and the water repellant compound may comprise a polyalkylsiloxane silicone fluid. The polyalkylsiloxane silicone fluid may be a modified or non- modified polyalkylsiloxane silicone fluid.

The resulting coating maintains a water contact angle of at least 60° for at least 20,000, and preferably at least 40,000 wipe cycles.

In other embodiments, the invention comprises a method for improving the water repellency of a surface, comprising a) applying to the surface a water repellant surface treatment comprising a silicone-containing compound and b) wiping the surface with a water repellant wiper blade comprising a natural or synthetic or semi-synthetic rubber squeegee body and a water repellant compound comprising a hydrophobic polymeric film former and a polyalkylsiloxane silicone fluid.

### DETAILED DESCRIPTION OF A PREFERRED EMBODIMENT

According to preferred embodiments, the present invention includes a wiper blade component and surface treatment.

### Surface Treatment

The surface treatment that may be used in the present invention preferably comprises a silicone composition that is applied to the windshield surface. The composition preferably contains at least one compound selected from the group comprising: polysiloxanes, chlorosilane compounds, alkoxysilane compounds, silazane compounds and agents composed mainly of these compounds. These compounds may be used alone or in various combinations. The compounds may be provided in a carrier fluid, in the form of a cream or lotion, emulsion or solution, solid, or in any other suitable form.

The surface treatment may be applied in any convenient manner, using methods including but not limited to spraying, wiping, dipping, painting, pouring, and the like. Preferably, a thin film of the surface treatment is applied to the surface. If the surface treatment is applied to a windshield or other glass, it may be preferable to apply a film that is sufficiently thin that its presence does not affect visibility through the glass.

Wiper blade

The wiper blade of the present invention can be any water repelling wiper blade that includes, but is not limited to, a polymeric film former and/or a silicon-based compound.

Some embodiments of the invention include wiper blades such as are described in Korean Patent Specification KR 10-0624180 B, which is incorporate herein by reference and excerpted below. Thus, in preferred embodiments, the wiper blade component of the present invention is preferably made of rubber or a similar material that has been coated with a water repellant coating. The coating preferably comprises at least a silicone oil and a resin that forms a polymeric film. In some embodiments, the coating comprises a 10-1200 parts by weight of graphite-containing solid lubricant, 50-2000 parts by weight of silicone oil and 100 parts by weight of a binder in a solvent.

In the present invention silicone oil and fine solid lubricant powder are preferably dispersed with a binder in a solvent to obtain a repellant composition, which is applied as the surface layer part on at least the active part of a wiper blade, that is, a layer of 5-30 μm thickness is formed on the wiper blade. Alternatively or in addition, the repellant composition may soak into the blade material. According to the present invention, silicone oil that is a water repellent ingredient contained in said coating composition is gradually eluted from the wiper blade so that a water repellent film may be formed automatically on the front windshield glass of an automobile that is in contact with a wiper blade.

It has been discovered that if the wiper blade prepared according to the present invention is used in addition to a separate water repellent treatment on a windshield, the result provides excellent durability of water repellent effects. In addition, substantially vibration-free operation can be realized by using solid lubricant powder.

The coating composition of the automobile wiper blade according to the present invention essentially includes fine solid lubricant powder and silicone oil.

In the present invention available solvents may be selected from a group comprising methyl ethyl ketone, toluene, xylene, isopropyl alcohol, and butyl acetate, and the combination of solvents may include a main resin, or two or more solvents may be formulated appropriately and used. In addition, the formulation of said solvents may be used at 800-8000 wt. parts with respect to 100 wt. parts of a binder. While combination and usage of said solvents is not particularly limited, it is particularly preferred that toluene and methyl ethyl ketone with low boiling points are primarily used, and xylene, isopropyl alcohol, and butyl acetate of high boiling points are combined and used, and 10-60 wt. parts of a high boiling solvent may be added with respect to 100 wt. parts of a low boiling solvent.

In the present invention a binder is preferably used to afford affinity of the coating composition toward the wiper blade and water repellency with respect to stretching properties of a blade, and selected from a group comprising polyol resin, urethane resin, fluorine resin containing hydroxide groups, epoxy resin, and silicone resin. More specifically, the polyol resin may include polyester polyol resin and polyether polyol resin, the urethane resin may include the urethane resin and silicone modified urethane resin, the epoxy resin may include urethane modified epoxy resin and diglycidyl ester resin, the silicone resin may include hydroxylterminated silicones and siloxane polymer substituted with dimethyl and silicone rubbers, and said silicone rubbers may include dimethyl silicone raw rubber, methyl phenyl vinyl silicone raw rubber, methyl vinyl silicone raw rubber, and fluorosilicone raw rubber. Therefore, if a binder satisfies affinity toward a wider blade and water repellency with respect to stretching properties of a blade depending upon required performance, one type alone or two or more types may be used in combination. In relation with this, in order to effectively satisfy the performance described above, it is preferred that hydroxyl-terminated silicones and siloxane polymer substituted with dimethyl is used among the binder types described above.

The available fine solid lubricant powder of the present invention preferably includes graphite as its essential ingredient (that is, fine solid lubricant powder containing graphite), and optionally at least one fine powder selected from a group comprising MoSO₂, polytetrafluoroethylene (PTFE), boron nitride, silicone resin, nylon resin, and polyethylene resin may be additionally used, and in particular, natural graphite of a needle shape is preferred. It is preferred that the average particle diameter of the solid lubricant powder ranges 2 to 15 μm. If the average particle diameter is less than 2 μm, lubrication properties may not be available, while if it exceeds 15 μm, wiping properties may become diminished. In the present invention, for the solid lubricant powder, graphite alone or two or more from the ingredients described above may be used. In addition, for the formulation of said solid lubricant powder, 10-1200 wt. parts are used with respect to 100 wt. parts of said binder, 80-870 wt. parts are preferred, and 50-520 wt. parts are further preferred. In addition, it is preferred that contents of graphite in said solid lubricant powder are 50-520 wt. parts with respect to 100 wt. parts of a binder. If contents of fine solid lubricant powder are less than 10 wt. parts, required lubrication properties may not be available, while if 1200 wt. parts are exceeded, the strength of the film may decrease and lubrication durability may be diminished.

In the present invention, suitable silicone oils include dimethyl silicone oil and optionally at least one silicone oil selected from a group comprising methyl phenyl silicone oil, methyl hydrodiene silicone oil, amino modified silicone oil, carboxyl modified silicone oil, carbinol modified silicone oil, phenol modified silicone oil, and polydimethyl siloxane modified substance may be additionally used, and dimethyl silicone is particularly preferred. In addition, said silicone oil has excellent initial water repellency as its viscosity goes down but its durability is poor, and while its viscosity goes up, its initial water repellency is poor but durability is excellent. In the present invention it is preferred that dynamic viscosity of said silicone oil is 10-500,00 cst at 20° C. In addition, for the formulation of said silicone oil, 50-2000 wt. parts are used with respect to 100 wt. parts of said binder, and 200-1400 wt. parts are preferred. If contents of said silicone oil are less than 50 wt. parts, sufficient water repellency may not be achieved, while if 2000 wt. parts are exceeded, film strength goes down and lubrication durability becomes an issue. In addition, if said silicone oil satisfies performance, dimethyl silicone oil alone or two or more ingredients described above may be combined and used.

In addition, in order to improve strength of the coating composition of the present invention and contain an oil, a filler may be additionally used. The filler is preferably selected from a group comprising fine silica powder, porous silica powder, porous acryl beads powder, urethane powder, silicone rubber powder, and combinations thereof. Silicone rubber powder is particularly preferred. If desired performance is satisfied, one or two or more ingredients above may be used. In addition, the filler preferably has an average particle diameter of 0.005-6 μm. In addition, with respect to 100 wt. parts of said binder, 3-500 wt. parts of filler are preferably used, and 30-350 wt. parts are preferred. If less than 3 wt. parts are used, an oil may not be sufficiently contained so intended additional effects (continued water repellency effects) may be difficult to attain, while 500 wt. parts are exceeded, it may be difficult for an silicone oil to elute on the film surface so it may be difficult to form initial water repellent films. If a filler is used, silicone oil is absorbed and contained more readily. For this reason, in addition to reinforcement effects of the coating composition, an oil may be preserved in a film for a long period, and effects of water repellency may be further prolonged.

In addition, for the coating composition, polyisocyanate, polyamide amine, aliphatic polyamine, alicyclic diamine, tertiary amine, and combinations thereof may be additionally used, and its quantity ranges 10-100 wt. parts with respect to 100 wt. parts of said binder. In addition, in order to promote curing of a main resin or the mixture of a main resin and a curing agent, a curing catalyst selected from a group comprising tin, platinum, and organic hydrogen peroxide may be added at 0.01-10 wt. parts with respect to 100 wt. parts of said binder.

The repellant composition according to the present invention described above is preferably prepared by diluting the binder in a solvent and essentially mixing and dispersing silicone oil and solid lubricant in the solution. A curing agent and a promoter may be added if needed. The repellant composition is applied to at least the blade part of an automobile wiper, that is, on the lip part, with a preferred film thickness of 5-30 μm, preferably at 5-15 μm. The application method may include spraying, wiping, dipping, brush painting, etc.

Thermal curing is preferably carried out after coating. It is preferred that the thermal curing is carried out at 50-180° C. for 30-60 minutes, the curing temperature of a binder and heat resistance of wiper blade materials are taken into consideration to establish a cure temperature. In addition, for the wiper blade on which the composition of the present invention may be coated, natural rubber, ethylene-propylene rubber, isopropylene rubber, stylene-butadiene rubber, chloroprene rubber, fluorine rubber, silicone rubber, and their mixed rubbers may be used. In particular, for non-adhering materials, silane primer treatment may be carried out before coating if required.

In particular embodiments, the wiper blade component of the present invention is preferably made of rubber or a similar material that has been coated with a water repellant coating. The coating preferably comprises at least a silicone oil. In some embodiments, the coating comprises a 10-1200 parts by weight, of graphite-containing solid lubricant, 50-2000 parts by weight of silicone oil and 100 parts by weight of a binder in a solvent.

The solid lubricant is preferably provided in the form of a powder having an average particle size of 2-15 μm. The solid lubricating powder is preferably selected from the group consisting of MoSO₂, polytetrafluoroethylene (PTFE), boron nitride, silicone resin, nylon resin, and polyethylene resin. The graphite is preferably present as 50-520 parts by weight based on 100 parts by weight of the binder.

The binder is preferably selected from the group consisting of polyol resins, urethane resins, hydroxyl group-containing fluorine resin, epoxy resin, and silicone resin, polyester polyol resin, polyether polyol resin, urethane resin, silicone-modified urethane resin, hydroxyl group-containing fluorine resin, urethane-modified epoxy resin, diglycidyl ester resin, silicone resin, dimethyl-substituted hydroxyl-terminate silicone and siloxane and silicone-based rubber. The silicone-based rubber may be dimethyl silicone crude rubber, methylphenylvinyl silicone crude rubber, methylvinyl silicone crude rubber, or fluoro silicone crude rubber.

The solvent may comprise methylethylketone, toluene, xylene, or butylacetate.

The silicone oil is preferably selected from the group consisting of methylphenyl silicone oil, methyl hydrogen silicone oil, amino-modified silicone oil, carboxyl-modified silicone oil, carbinol-modified silicone oil, phenol-modified silicone oil, and modified polydimethylsiloxane.

The coating composition may also include a filler selected from the group consisting of fine silica powder, porous silica powder, porous acrylic bead powder, urethane powder, and silicone rubber powder, with an average particle size of 0.005-6 μm. The filler may be present as 3-500 parts by weight based on 100 parts by weight of the binder.

The coating composition may also include a curing agent selected from the group consisting of polyisocyanates, polyamide amines, aliphatic polyamines, alicyclic diamines, and tert-amines. The curing agent may be present as 10-100 parts by weight based on 100 parts by weight of the binder.

The coating composition is preferably applied to the blade such that it forms a film on the blade, with the film being in the range of 5-30 μm thick.

The body of each wiper blade is preferably made of cured natural rubber or synthetic rubber or a mixture of them. In addition, there may be other blade materials that would work in the present invention.

The following Examples are from Korean Patent Specification KR 10-0624180 B.

### EXAMPLE 1

In a solvent prepared by mixing 3700 wt. parts of methyl ethyl ketone, 2600 wt. parts of toluene, and 1300 wt. parts of butyl acetate, was dissolved the binder of polyester polyol resin (BYK-AG product, Desmophen 670) at 100 wt. parts, and in said solution were mixed and dispersed 350 wt. parts of the silicone rubber (Dow Corning Toray, E-500) of 3 μm in the average particle diameter as a filler 520 wt. parts of needle-shaped natural graphite (Chuetsu Graphite Works, FBF) of 4 μm in the average particle diameter as a fine solid lubricant powder, and 520 wt. parts of dimethyl silicone oil (Shinetsu Chemical, KF 96-50 cs) with the dynamic viscosity of 50 cst at 20° C. as a silicone oil to obtain the coating composition. To said coating composition were added 75 wt. parts of polyisocyanate (Nippon Polyurethane Industry, Coronate HL) as a curing agent, spray coating was carried out on the wiper blade of natural rubber materials to form the film of 10 μm in thickness before curing was carried out at 80° C. for 30 min. For the automobile wiper blades prepared the tests described below were carried out, and its evaluation results are listed in Table 1 and Table 2 below.

### EXAMPLE 2

It was carried out as in said Example 1 except that 60 wt. parts of a silicone rubber with the average particle diameter of 3 μm were used as a filler, 150 wt. parts of needle-shaped natural graphite with the average particle diameter of 4 μm were used as fine solid lubricant powder, and 400 wt. parts of a dimethyl silicone oil with dynamic viscosity of 50 cst at 20° C. were used as a silicone oil. For the automobile wiper blades prepared the tests described below were carried out, and its evaluation results are listed in Table 1 and Table 2 below.

### EXAMPLE 3

It was carried out as in said Example 1 except that 100 wt. parts of a silicone rubber with the average particle diameter of 3 μm were used as a filler, 200 wt. parts of needle-shaped natural graphite with the average particle diameter of 4 μm were used as fine solid lubricant powder, and 450 wt. parts of a dimethyl silicone oil with dynamic viscosity of 50 cst at 20° C. were used as a silicone oil. For the automobile wiper blades prepared the tests described below were carried out, and its evaluation results are listed in Table 1 and Table 2 below.

### EXAMPLE 4

It was carried out as in said Example 1 except that a filler was not used, 150 wt. parts of needleshaped natural graphite with the average particle diameter of 4 μm, 290 wt. parts of MoSO₂ (Endako Mines, UP-10), and 70 wt. parts of a silicone resin (GE Silicones, Tospearl 130) were used as fine solid lubricant powder, and 480 wt. parts of a dimethyl silicone oil with dynamic viscosity of 50 cst at 20° C. were used as a silicone oil. For the automobile wiper blades prepared the tests described below were carried out, and its evaluation results are listed in Table 1 and Table 2 below.

### EXAMPLE 5

It was carried out as in said Example 1 except that a filler was not used, 90 wt. parts of needleshaped natural graphite with the average particle diameter of 4 μm, 340 wt. parts of MoSO₂ and 100 wt. parts of a silicone resin were used as fine solid lubricant powder, and 480 wt. parts of a dimethyl silicone oil with dynamic viscosity of 50 cst at 20° C. were used as a silicone oil. For the automobile wiper blades prepared the tests described below were carried out, and its evaluation results are listed in Table 1 and Table 2 below.

### EXAMPLE 6

It was carried out as in said Example 1 except that a filler was not used 320 wt. parts of needleshaped natural graphite with the average particle diameter of 4 μm and 210 wt. parts of PTFE (Kimamura, KIL-8F) were used as fine solid lubricant powder, and 480 wt. parts of a dimethyl silicone oil with dynamic viscosity of 50 cst at 20° C. were used as a silicone oil. For the automobile wiper blades prepared the tests described below were carried out, and its evaluation results are listed in Table 1 and Table 2 below.

### EXAMPLE 7

It was carried out as in said Example 1 except that a filler was not used 520 wt. parts of needleshaped natural graphite with the average particle diameter of 4 μm and 350 wt. parts of PTFE were used as fine solid lubricant powder, and 520 wt. parts of a dimethyl silicone oil with dynamic viscosity of 50 cst at 20° C. were used as a silicone oil. For the automobile wiper blades prepared the tests described below were carried out, and its evaluation results are listed in Table 1 and Table 2 below.

### EXAMPLE 8

In the solvent prepared by mixing 600 wt. parts of methyl ethyl ketone and 350 wt. parts of butyl acetate, were dissolved 100 wt. parts of a fluorine resin containing hydroxide groups (Dainippon Ink And Chemicals, Fluonate K-702) as a binder, and in said solution were mixed and dispersed 45 wt. parts of a silicone rubber (Dow Corning Toray, E-500) with the average particle size of 3 μm as a filler, 20 wt. parts of PTFE (Kimamura, KTL-8F) with the average particle diameter of 3 μm and 60 wt. parts of needle-shaped natural graphite (Chuetso Graphite Works, FBF) as fine solid lubricant powder, and 280 wt. parts of dimethyl silicone oil (Shinetsu Chemical, KF 96-50cs) with the dynamic viscosity of 50 cst at 20° C. and 120 wt. parts of a polydimethyl siloxane modified substance with the dynamic viscosity of 300 cst to prepared a coating composition. To said coating composition were added 42 wt. parts of polyisocyanate (Dainippon Ink And Chemicals, Burnock DN-955) as a curing agent, spray coating was carried out on the wiper blade of natural rubber materials to form the film of 10 m in thickness before curing was carried out at 80 C for 30 min. For the automobile wiper blades prepared the tests described below were carried out, and its evaluation results are listed in Table 1 and Table 2 below.

### EXAMPLE 9

It was carried out as in said Example 8 except that 140 wt. parts of a dimethyl silicone oil with the dynamic viscosity of 50 cst at 20° C. and 60 wt. parts of a polydimethyl siloxane modified substance with the dynamic viscosity of 20 cst were used as a silicone oil. For the automobile wiper blades prepared the tests described below were carried out, and its evaluation results are listed in Table 1 and Table 2 below.

### EXAMPLE 10

It was carried out as in said Example 8 except that 200 wt. parts of a dimethyl silicone oil with the dynamic viscosity of 50 cst at 20° C. and 200 wt. parts of a amino modified silicone oil (Shinetsu Chemical, KF 856) with the viscosity of 60 cst were used as a silicone oil. For the automobile wiper blades prepared the tests described below were carried out, and its evaluation results are listed in Table 1 and Table 2 below.

### EXAMPLE 11

It was carried out as in said Example 8 except that 100 wt. parts of a dimethyl silicone oil with the dynamic viscosity of 50 cst at 20° C. and 100 wt. parts of a amino modified silicone oil (Shinetsu Chemical, KF 856) with the viscosity of 60 cst were used as a silicone oil. For the automobile wiper blades prepared the tests described below were carried out, and its evaluation results are listed in Table 1 and Table 2 below.

### EXAMPLE 12

It was carried out as in said Example 8 that 360 wt. parts of a dimethyl silicone oil with the dynamic viscosity of 50 cst at 20° C. and 40 wt. parts of a dimethyl silicone oil (Shinetsu Chemical, KF 96-10000 CS) with the viscosity of 10,000 cst were used as a silicone oil. For the automobile wiper blades prepared the tests described below were carried out, and its evaluation results are listed in Table 1 and Table 2 below.

### EXAMPLE 13

It was carried out as in said Example 8 that 180 wt. parts of a dimethyl silicone oil with the dynamic viscosity of 50 cst at 20° C. and 20 wt. parts of a dimethyl silicone oil with the viscosity of 10,000 cst were used as a silicone oil. For the automobile wiper blades prepared the tests described below were carried out, and its evaluation results are listed in Table 1 and Table 2 below.

### EXAMPLE 14

In the solvent prepared by mixing 2000 wt. parts of toluene and 700 wt. parts of xylene were dissolved 100 wt. parts of hydroxyl-terminated silicone and siloxane polymer substituted with dimethyl (GE Silicones, YSR 3022) as a binder, and in said solution were mixed and dispersed 80 wt. parts of a silicone rubber (Dow Corning Toray, E-500) with the average particle diameter of 3 μm as a filler, needle-shaped natural graphite (Chuetso Graphite Works, FBF) with the average particle diameter of 4 μm as a fine solid lubricant powder, and 600 wt. parts of a dimethyl silicone oil (Shinetsu Chemical, KF 96-50CS) with the dynamic viscosity of 60 cst and 600 wt. parts of amino modified silicone oil (Shinetsu Chemical, KF-856) with the dynamic viscosity of 60 cst as an silicone oil to prepare a coating composition. To said coating composition were added 10 wt. parts of dibutyl tin diacetate as a curing agent, spray coating was carried out on the wiper blade of natural rubber materials to form the film of 10 μm in thickness before curing was carried out at 80° C. for 30 min. For the automobile wiper blades prepared the tests described below were carried out, and its evaluation results are listed in Table 1 and Table 2 below.

### EXAMPLE 15

It was carried out as in said Example 14 except that 30 wt. parts of a silicone rubber with the average particle diameter of 3 μm were used as a filler, 50 wt. parts of needle-shaped natural graphite (Chuetsu Graphite Works, FBF) with the average particle diameter of 4 μm and 130 wt. parts of MoSO₂ (Endako Mines, UP-10) were used as a fine solid lubricant powder, and 290 wt. parts of a dimethyl silicone oil (Shinetsu Chemical, KF 96-50 cs) with the dynamic viscosity of 50 cst at 20° C. and 290 wt. parts of an amine modified silicone oil (Shinetsu Chemical, KF 856) with the dynamic viscosity of 60 cst were used as a silicone oil. For the automobile wiper blades prepared the tests described below were carried out, and its evaluation results are listed in Table 1 and Table 2 below.

### EXAMPLE 16

It was carried out as in said Example 14 except that 50 wt. parts of a silicone rubber with the average particle diameter of 3 μm were used as a filler, 110 wt. parts of needle-shaped natural graphite with the average particle diameter of 4 μm and 270 wt. parts of MoSO₂ were used as a fine solid lubricant powder, and 460 wt. parts of a dimethyl silicone oil with the dynamic viscosity of 50 cst at 20° C. and 460 wt. parts of an amine modified silicone oil with the dynamic viscosity of 60 cst were used as a silicone oil. For the automobile wiper blades prepared the tests described below were carried out, and its evaluation results are listed in Table 1 and Table 2 below.

### EXAMPLE 17

It was carried out as in said Example 14 except that 90 wt. parts of a silicone rubber with the average particle diameter of 3 μm were used as a filler, 180 wt. parts of needle-shaped natural graphite with the average particle diameter of 4 μm and 460 wt. parts of MoSO₂ were used as a fine solid lubricant powder, and 700 wt. parts of a dimethyl silicone oil with the dynamic viscosity of 50 cst at 20° C. and 700 wt. parts of an amine modified silicone oil with the dynamic viscosity of 60 cst were used as a silicone oil. For the automobile wiper blades prepared the tests described below were carried out, and its evaluation results are listed in Table 1 and Table 2 below.

### COMPARATIVE EXAMPLE 1

In the solvent prepared by mixing 3700 wt. parts of methyl ethyl ketone, 2600 wt. parts of toluene, and 1300 wt. parts of butyl acetate, was dissolved the binder of polyester polyol resin (BYK-AG product, Desmophen 670) at 100 wt. parts, and in said solution were mixed and dispersed 350 wt. parts of the silicone rubber (Dow Corning Toray, E-500) of 3 μm in the average particle diameter as a filler, 530 wt. parts of needle-shaped natural graphite (Chuetsu Graphite Works, FBF) of 4 μm in the average particle diameter as a fine solid lubricant powder, and 45 wt. parts of dimethyl silicone oil (Shinetsu Chemical, KF 96-50 cs) with the dynamic viscosity of 50 cst at 20° C. as a silicone oil to obtain the coating composition.

To said coating composition were added 75 wt. parts of polyisocyanate (Nippon Polyurethane Industry, Coronate HL) as a curing agent, spray coating was carried out on the wiper blade of natural rubber materials to form the film of 10 μm in thickness before curing was carried out at 80° C. for 30 min. For the automobile wiper blades prepared the tests described below were carried out, and its evaluation results are listed in Table 1 and Table 2 below.

### COMPARATIVE EXAMPLE 2

It was carried out as in said Comparative Example 1 except that a silicone was not used. For the automobile wiper blades prepared the tests described below were carried out, and its evaluation results are listed in Table 1 and Table 2 below. Comparative Example 3 It was carried out as in said Comparative Example 1 except that 1050 wt. parts of a dimethyl silicone oil with the dynamic viscosity of 50 cst at 20° C. and 1050 wt. parts of an amino modified silicone oil (Shinetsu Chemical, KF 856) with the dynamic viscosity of 60 cst at 20 C were used as a silicone oil. For the automobile wiper blades prepared the tests described below were carried out, and its evaluation results are listed in Table 1 and Table 2 below.

### COMPARATIVE EXAMPLE 4

It was carried out as in Comparative Example 1 except that a filler was not used, 4.0 wt. parts of needle-shaped natural graphite with the average particle diameter of 4 μm and 3.5 wt. parts of MoSO₂ were used as a fine solid lubricant powder, and 480 wt. parts of a dimethyl silicone oil with the dynamic viscosity of 50 cst at 20° C. were used as a silicone oil. For the automobile wiper blades prepared the tests described below were carried out, and its evaluation results are listed in Table 1 and Table 2 below.

### COMPARATIVE EXAMPLE 5

It was carried out as in Comparative Example 1 except that a filler was not used, 1250 wt. parts of MoSO₂ with the average particle diameter of 4 μm were used as a fine solid lubricant powder, and 520 wt. parts of a dimethyl silicone oil with the dynamic viscosity of 50 cst at 20° C. were used as silicone oil. For the automobile wiper blades prepared the tests described below were carried out, and its evaluation results are listed in Table 1 and Table 2 below.

### *Contact Mobility and Initial Water Repellency Tests of Wiper *

A tester that meets the tester used to evaluate performance of the wiper blade prescribed in JIS D5710 was used, operated under the anhydrous condition, and water repellency and operating current are checked after 15 minutes. Operating current is evaluated in terms of an index based on that the value of an uncoated wiper blade of natural rubber is set as 100. It may be said that a lower index represents excellent contact mobility of a wiper.

Evaluation Criteria of Water Repellency:
O: entire face of contact part repels water/good performance
Δ: at least 50% of contact part repels water/slightly poor performance
X: less than 50% of contact part repels water/poor performance.

Water Repellency and Durability Test

A tester that meets the tester used to evaluate performance of the wiper blade prescribed in JIS D5710 is used, and it is operated under the anhydrous condition before the wiper is operated 300,000 times when water is sprayed uniformly on the windshield glass of an automobile at 500 cc/min. The operation speed of the wiper blade is 40 cycles/min. Evaluation is carried out every 50,000 times. However, if vibrations are significant and operations not smooth, the test is suspended.

Evaluation Criteria of Water Repellency and Durability
O: at least 70% of contact part repels water/slightly good performance
Δ: at least 50% of contact part repels water/slightly poor performance
X: less than 50% of contact part repels water/poor performance.

TABLE 1
Contact Mobility Water Repellency

| | | |
|---|---|---|
| Example 1 | 89 | ◯ |
| Example 2 | 95 | ◯ |
| Example 3 | 95 | ◯ |
| Example 4 | 90 | ◯ |
| Example 5 | 90 | ◯ |
| Example 6 | 92 | ◯ |
| Example 7 | 89 | ◯ |
| Example 8 | 95 | ◯ |
| Example 9 | 92 | ◯ |
| Example 10 | 95 | ◯ |
| Example 11 | 92 | ◯ |
| Example 12 | 97 | ◯ |
| Example 13 | 97 | ◯ |
| Example 14 | 87 | ◯ |
| Example 15 | 90 | ◯ |
| Example 16 | 90 | ◯ |
| Example 17 | 88 | ◯ |
| ComparativeExample 1 | 92 | X |
| ComparativeExample 2 | 95 | X |
| ComparativeExample 3 | 90 | ◯ |
| ComparativeExample 4 | 110 | ◯ |
| ComparativeExample 5 | 97 | ◯ |

TABLE 2

| | 50,000 | 100,000 | 150,000 | 200,000 | 250,000 | 300,000 |
|---|---|---|---|---|---|---|
| | Times | times | times | times | times | Times |
| Example 1 | ◯ | ◯ | ◯ | ◯ | ◯ | ◯ |
| Example 2 | ◯ | ◯ | ◯ | ◯ | ◯ | ◯ |
| Example 3 | ◯ | ◯ | ◯ | ◯ | ◯ | ◯ |
| Example 4 | ◯ | ◯ | ◯ | ◯ | ◯ | ◯ |
| Example 5 | ◯ | ◯ | ◯ | ◯ | ◯ | ◯ |
| Example | ◯ | ◯ | ◯ | ◯ | ◯ | ◯ |
| Example 7 | ◯ | ◯ | ◯ | ◯ | ◯ | ◯ |
| Example 8 | ◯ | ◯ | ◯ | ◯ | ◯ | Δ |
| Example 9 | ◯ | ◯ | ◯ | ◯ | Δ | Δ |
| Example 10 | ◯ | ◯ | ◯ | ◯ | ◯ | Δ |
| Example 11 | ◯ | ◯ | ◯ | ◯ | Δ | Δ |
| Example 12 | ◯ | ◯ | ◯ | ◯ | ◯ | Δ |
| Example 13 | ◯ | ◯ | ◯ | ◯ | Δ | Δ |
| Example 14 | ◯ | ◯ | ◯ | ◯ | ◯ | ◯ |
| Example 15 | ◯ | ◯ | ◯ | ◯ | ◯ | ◯ |
| Example 16 | ◯ | ◯ | ◯ | ◯ | ◯ | ◯ |
| Example 17 | ◯ | ◯ | ◯ | ◯ | ◯ | ◯ |
| Comparative | X | X | X | X | X | X |
| Example 1 | | | | | | |
| Comparative | X | X | X | X | X | X |
| Example 2 | | | | | | |
| Comparative | ◯ | sus- | sus- | sus- | sus- | sus- |
| Example 3 | | pended | pended | pended | pended | pended |
| Comparative | ◯ | sus- | sus- | sus- | sus- | sus- |
| Example 4 | | pended | pended | pended | pended | pended |
| Comparative | ◯ | sus- | sus- | sus- | sus- | sus- |
| Example 5 | | pended | pended | pended | pended | pended |

As may be seen from the above Examples and Comparative Examples, when the coating composition for automobile wiper blades is formed on the wiper blade as a surface layer, at least on its lip part, at the film thickness of 5-30 μm, a water repellent film coating with excellent durability can be formed on the windshield glass of an automobile automatically by merely operating wiper blades. In addition, because the automobile windshield glass repels water well, rain drops can be easily dispersed, a good viewing field can be obtained, noise or vibration of a wiper blade can be prevented, and smooth-operating wiper blades can be provided.

### Operation

When it is desired to obtain a durable water repellant coating on a windshield, the surface of the windshield is treated with the surface treatment as described above, and a hydrophobic wiper blade as described above is affixed to the vehicle. As the system is operated, the combination of surface treatment and hydrophobic wiper blade forms a durable water repellant coating on the windshield. The resulting coating maintains its water repellency, as indicated by measured contact angle, for at least 20,000 and typically at least 40,000 wipe cycles. More specifically, the resulting coating maintains a water contact angle of at least 60° for at least 20,000 and typically at least 40,000 wipe cycles.

What is claimed is:

1. A system for creating a water repellant coating on a windshield surface, comprising:
a water repellant surface treatment comprising a silicone-containing compound applied to the surface; and
a water repellant wiper blade comprising a natural or synthetic or semi-synthetic rubber squeegee body and a water repellant compound comprising a hydrophobic polymeric film former and a hydrophobicity-enabling agent.

2. The system according to claim 1 wherein the water repellant surface treatment comprises at least one compound selected from the group comprising: polysiloxanes, chlorosilane compounds, alkoxysilane compounds, silazane compounds, and combinations thereof.

3. The system according to claim 1 wherein the water repellant surface treatment is provided in a carrier fluid in the form of a cream, lotion, emulsion, solution, or solid.

4. The system according to claim 1 wherein the polymeric film former comprises a compound selected from the group consisting of polyol resins, urethane resins, fluorine resins, epoxy resins, and silicone resins.

5. The system according to claim 1 wherein the water repellant compound further includes a friction reducing agent selected from the group consisting of graphite, PTFE, and molybdenum disulfide powders.

6. The system according to claim 1 wherein the water repellant compound is a polyalkylsiloxane silicone fluid.

7. The system according to claim 6 wherein the polyalkylsiloxane silicone fluid is a modified polyalkylsiloxane silicone fluid.

8. The system according to claim 1 wherein the resulting coating maintains a water contact angle of at least 60° for at least 20,000 wipe cycles.

9. The system according to claim 1 wherein the resulting coating maintains a water contact angle of at least 60° for at least 40,000 wipe cycles.

10. A method for improving the water repellency of a surface, comprising:
a) applying to the surface a water repellant surface treatment comprising a silicone-containing compound; and
b) wiping the surface with a water repellant wiper blade comprising a natural or synthetic or semi-synthetic rubber squeegee body and a water repellant compound comprising a hydrophobic polymeric film former and a polyalkylsiloxane silicone fluid.
